(19) United States
(12) Patent Application Publication
(10) Pub. No.: US 2007/0266153 A1
(43) Pub. Date: Nov. 15, 2007

(54) Video signal processing apparatus and methods

(75) Inventors: Timothy Alan Barrett, Kanata (CA); Ben Crosby, Southbank (AU)

Correspondence Address: Arnold B. Silverman;Eckert Seamans Cherin & Mellott, LLC, 44th Floor, 600 Grant Street, Pittsburgh, PA, 15219, US

(73) Assignee: Alcatel

(21) Appl. No.: 11/411,268

(22) Filed: Apr. 26, 2006

(51) Int. Cl. H04N 7/18; G06F 15/173; H04N 9/47

(52) U.S. Cl. 709/225; 348/61

(57) ABSTRACT

Video signal processing apparatus and methods are disclosed. An access termination terminates an access communication link that operatively couples a video service customer site to a communication network in which communication signals comprising video signals are distributed to video service customer sites. A video signal processor is co-located with the access termination and is operable to receive communication signals from the access termination, to extract a video signal from the received communication signals, and to output the extracted video signal for transfer to a display system at the video service customer site. Control signals may be received by the video signal processor from the display system over the same connection used to transfer video signals to the display system, or through a different connection such as a wireless connection. Video functions including video recording and other functions normally associated with set top video decoders may also be supported.

### FIELD OF THE INVENTION

This invention relates generally to video signal processing and, in particular, to processing video signals such as television signals distributed through communication networks.

### BACKGROUND

Relative to traditional broadcast television (TV) services, other video signal distribution schemes such as Internet Protocol TV (IPTV) can be complex and expensive. IPTV, for example, requires IP home networking and set top boxes to be installed. These requirement makes it difficult for IPTV to compete with a basic cable service, which involves a much cheaper and simpler connection or network of coaxial cabling.

In addition to the cost of set top or decoder boxes, there is significant cost associated with just cabling a customer's home to be able to deliver a reliable, high-bandwidth IP service to multiple rooms. Wireless technologies may solve this part of the problem in the future, but are presently inadequate. Other possible solutions can provide network connectivity inside the home, using either existing wiring or new wiring. However, all of these networking techniques tend to involve relatively high costs, be complex, and have potential issues with reliability.

Customers of a video service may have no interest in the additional benefits that a high speed internet service brings. For a service provider providing a video service via a communications network, the costs of installing a home network can therefore be difficult to justify, and a lower cost deployment model would be useful for at least those potential customers. As noted above, there can be significant cost and complexity in currently available networking solutions, which makes it very difficult for communication network-based video services to compete with more conventional basic video services.

### SUMMARY OF THE INVENTION

Some embodiments of the invention remove the need for set top video decoder boxes or home networking when deploying an IPTV service. Service providers can thus provide an IPTV video service, for example, without deploying multiple boxes and IP networking for the home.

A mechanism may also be provided to convert IP video streams or other types of video signals into standard video inputs for legacy televisions.

Embodiments of the invention can be implemented to provide a very low cost, simply installed solution that works well for many potential video service customers, filling a substantial gap at the low end, and possibly expanding into the high end.

According to an aspect of the invention, a device includes an access termination for terminating and connection to an access communication link that operatively couples a video service customer site to a communication network, the communication network distributing communication signals comprising video signals to a plurality of video service customer sites, and a video signal processor operatively coupled to the access termination and operable to receive communication signals from the access termination, to extract a video signal from the received communication signals, and to output the extracted video signal for transfer to a display system at the video service customer site.

The communication network may be IP network, and the video signals may include television signals.

In some embodiments, the video signal processor includes a video decoder that is operable to extract a video signal from the received communication signals by decoding the video signal.

The device may also include a video signal memory operatively coupled to the video signal processor. In this case, the video signal processor may be further operable to store the extracted video signal to the video signal memory, and to subsequently retrieve the stored video signal from the video signal memory for transfer to the display system. The video signal processor may also be operable to extract a further video signal from the received communication signals, to store the extracted further video signal to the video signal memory, and to subsequently retrieve the stored further video signal from the video signal memory for transfer to the display system.

In some embodiments, the device includes a remote control interface operatively coupled to the video signal processor and operable to receive a remote control signal from the display system. The video signal processor receives the remote control signal from the remote control interface and adjusts its operation in accordance with the received remote control signal.

If the remote control signal is a video signal selection, the video signal processor adjusts its operation to extract the selected video signal from the received communication signals responsive to the remote control signal.

The device may also include a display system interface operatively coupled to the video signal processor and operable to receive the extracted video signal from the video signal processor and to transfer the extracted video signal to the display system over a customer site connection. The remote control interface may be operable to receive the remote control signal from the display system over the same customer site connection.

A video signal translator may also be operatively coupled to the video signal processor and operable to receive the extracted video signal from the video signal processor in a first format, and to translate the extracted video signal into a second different format for transfer to the display system.

One possible implementation of the device includes a modular video signal processing component, and the device includes multiple connectors for respectively operatively coupling multiple video signal processors including the video signal processor to the access termination.

The video signal processor itself may include multiple video signal processor connectors for respectively operatively coupling modular components to the video signal processors. The modular components may include, for example, a video signal memory and a video signal translator.

In a device for terminating an access communication link that operatively couples a video service customer site to a communication network in which communication signals comprising video signals are distributed to a plurality of video service customer sites, a method according to another aspect of the invention includes extracting a video signal from the received communication signals, and outputting the extracted video signal for transfer to a display system at the video service customer site.

As noted above, the communication network may be an IP network, and the video signals may include television signals.

The operation of extracting may involve decoding the video signal.

In some embodiments, the method also includes storing the extracted video signal to a video signal memory, and outputting involves subsequently retrieving the stored video signal from the video signal memory for transfer to the display system.

If a remote control signal is received from the display system, the extracting is adjusted in accordance with the received remote control signal.

The method may also include transferring the extracted video signal to the display system over a customer site connection, and receiving a remote control signal from the display system over the same customer site connection.

If the extracted video signal comprises a video signal format, the method may also include translating the extracted video signal into a different video signal format for transfer to the display system.

The method may be embodied, for example, in instructions stored on a machine-readable medium.

A further aspect of the invention provides a video display control system that includes a video signal interface for receiving, on a connection to a video signal processor, video signals extracted by the video signal processor from communication signals distributed in a communication network, and a video control interface operatively coupled to the connection and operable to receive a video control signal from a user and to transfer the received video control signal to the video signal processor over the connection.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of a communication system.

FIG. 2 is a block diagram of a device according to an embodiment of the invention.

FIG. 3 is a block diagram of a display system.

FIG. 4 is a flow diagram illustrating a method according to another embodiment of the invention.

### DETAILED DESCRIPTION OF PREFERRED EMBODIMENTS

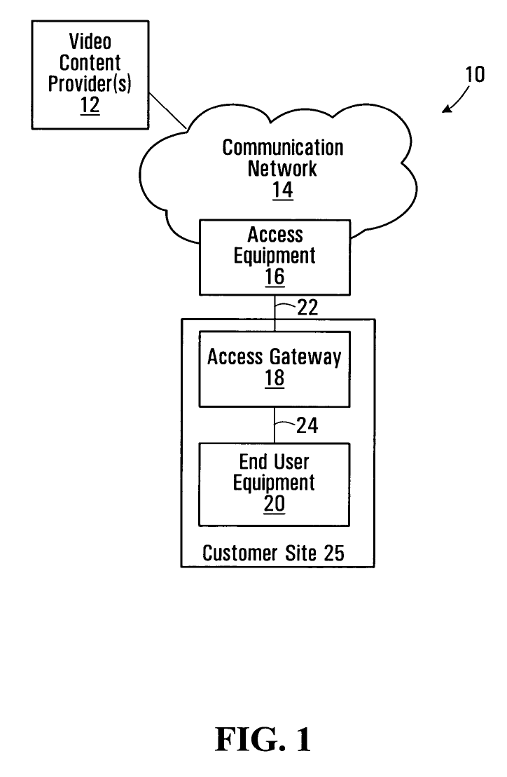

FIG. 1 is a block diagram of a communication system in which embodiments of the invention may be implemented. The communication system 10 includes one or more video content providers generally represented at 12, a communication network 14, access equipment 16, an access gateway 18 that is operatively coupled to the access equipment through a communication link 22, and end user equipment 20 that is operatively coupled to the access gateway through a connection 24. The access gateway 18, the end user equipment 20, and the connection 24 are generally referred to herein as a customer site 25.

Although many installations of access equipment, access gateways, and end user equipment may be connected to a communication network, only one example of each type of system has been shown in FIG. 1 so as to avoid overly complicating the drawing. It should therefore be appreciated that the system of FIG. 1, as well as the contents of the other drawings, are intended solely for illustrative purposes, and that the present invention is in no way limited to the particular example embodiments explicitly shown in the drawings and described herein.

The video content provider(s) block at 12 represents one or more systems operated by respective video service providers. Video content may be, for example, video signals that include at least some content for display on display devices, illustratively televisions. It should be appreciated, however, that the actual extent of visual content in different video signals may vary. Some television channels, for example, include primarily (or solely) audio content for playback through an audio subsystem of a video display device. References herein to video signals should be interpreted accordingly.

A video content provider 12 may generate, store, or both generate and store video content, and distribute that video content to its subscribers through the communication network 14. Those skilled in the art will be familiar with many such generation and distribution schemes. Intermediate components in the communication network 14 and/or between the video content provider(s) 12 and the communication network may be involved in these functions, for example. Since embodiments of the present invention relate primarily to customer-end processing, however, generation and distribution functions are described herein only to the extent necessary to illustrate aspects of the invention. In general, a video content provider system 12 performs such functions as formatting video content into video signals that can be transferred in communication signals through the communication network 14 and the access equipment 16 to the access gateway 18 and finally to the end user equipment 20.

Many examples of communication networks through which video signals may be distributed, as well as their operation, will also be apparent to those skilled in the art. In one embodiment of the invention, the communication network is an IP network that is used by the video content provider(s) 12 to provide IPTV services.

The access equipment 16 provides the access gateway 18, and thus the customer site 25, with access to the communication network 14. An IP Digital Subscriber Line Access Multiplexer (DSLAM) is one example of a possible implementation of the access equipment 16. In this case, the access link 22 might be provided using one or more copper pairs.

The access gateway 18 terminates the network access connection 22 through which the customer site 25 is operatively coupled to the communication network 14. In the case of an optical fibre access connection 22, the access gateway 18 may be an Optical Network Termination (ONT) unit. Some form of modem or residential gateway might instead be used for xDSL or optical fibre based access technologies. Such devices for xDSL may be known as Intelligent Network Interface Devices (iNIDs) or Copper Network Terminations (CNTs). A residential gateway may be a more “intelligent” component, being manageable, providing firewall capability, etc., in some embodiments. For each of these, there is potentially an integrated residential gateway function, providing additional IP routing, security, network address translation, or other services.

The TV functionality in an IPTV service is usually provided through a set top box or decoder box, as noted above. This type of device is connected to a broadband home network, and decodes IP video streams then displays them on a TV. The end user equipment 20, in a conventional IPTV deployment, would thus include one or more set top boxes and one or more TVs. Where more than one TV is to receive video service, the connection 24 would include multiple connections for carrying video signals output by multiple video decoder devices.

According to an aspect of the invention, rather than have a separate set top box connected to a TV as part of the end user equipment 20, core video processing functionality of a set top box is co-located with or integrated into a device that also terminates the carrier or distribution network. A System on Chip (SoC) or other integrated device such as that used in a traditional set top box, for example, could be used to provide video signal processing functions. Video signals can then be decoded and output over a less costly, and often existing, connection such as a Radio Frequency (RF) video connection jack, illustratively an f-type antenna jack for North American installations. Many ONT devices already have an appropriate connection for either an analog or digital cable video service. A video signal receiver in a TV can then be used to receive video signals from the cable.

In some embodiments, remote control signals are passed back to the embedded video signal processing device at an access termination either through the video cable or wirelessly.

It may also be possible to extend the concept of centralized termination and video signal processing to include an additional operation of re-encoding a video stream into a standard Moving Picture Experts Group (MPEG) format such as MPEG-2, Advanced Television Systems Committee (ATSC) digital format, and/or other formats that may vary by geographical region such as Digital Video Broadcast-Terrestrial (DVB-T), to allow a high-quality digital and potentially high definition video stream to be delivered to existing television sets over less complex, lower cost, and often existing cabling instead of through a home network.

Further, a level of modularization of these and possibly other functionalities might allow for multiple video signal processors to be deployed with an access termination device to address the same issues for multiple TV sets at one video service customer site.

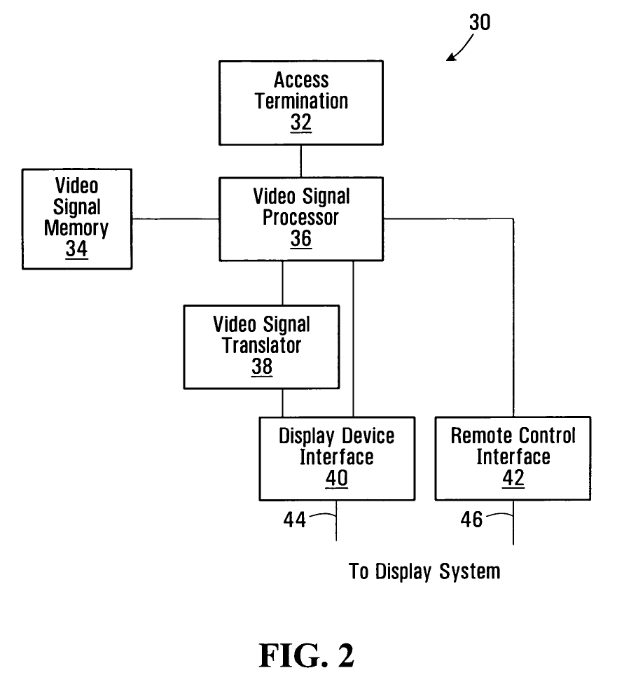

These and other aspects of the invention will be further illustrated-with reference to FIGS. 2 through 4.

FIG. 2 is a block diagram of a device according to an embodiment of the invention. The device 30, which might be incorporated into an ONT, an iNID, or a CNT housing for instance, includes an access termination 32, a video signal processor 36 operatively coupled to the access termination, a video signal memory 34 operatively coupled to the video signal processor, a video signal translator 38 operatively coupled to the video signal processor, a display device interface 40 operatively coupled to the video signal translator and to the video signal processor, and a remote control interface 42 operatively coupled to the video signal processor. The interfaces 40, 42 are operatively coupled to a display system at a video service customer site through customer site connections 44, 46, which may be the same connection or different connections.

The device 30 represents an example of one possible implementation of an embodiment of the invention. The invention is in no way limited to the specific implementation shown in FIG. 2. For example, the functions of the video signal processor 36 and the video signal translator 38 could be supported by a single functional element in other embodiments. Similarly, although two interfaces 40, 42 and two customer site connections 44, 46 are shown, video signals and remote control signals might be transferred between the device 30 and a display system through the same physical connection.

Thus, more generally, embodiments of the invention may have fewer, further, or different components with similar or different interconnections than shown in FIG. 2 and the other drawings.

The types of connections through which the components of FIG. 2 are operatively coupled may, to at least some extent, be implementation-dependent. Electronic devices often use various types of physical connectors and wired connections for component interconnections. In the case of cooperating software functions, for example, an operative coupling may be through variables or registers, and thus be a form of logical coupling rather than a physical coupling.

The video signal memory 34 includes one or more memory devices, such as a solid state memory device and/or a memory device that operates in conjunction with a movable or removable storage medium. Although shown as part of the device 30, the video signal memory 34 may be internal or external to a device that integrates the other components.

Any or all of the other components of the device 30 may be implemented in hardware, software, firmware, or combinations thereof. Electronic components that may be suitable for this purpose include, among others, microprocessors, microcontrollers, Programmable Logic Devices (PLDs), Field Programmable Gate Arrays (FPGAs), Application Specific Integrated Circuits (ASICs), and other types of “intelligent” integrated circuits. The device 30 is therefore described herein primarily in terms of its function. Based on the functional description, a person skilled in the art will be enabled to implement the device 30 in any of various ways.

In operation, the access termination 32 terminates an access communication link that operatively couples the device 30, which is part of a video service customer site, to a communication network. Communication signals that include video signals are distributed to video service customer sites through the communication network. Those skilled in the art will be familiar with many examples of access terminations. The access termination 32 may include components that are used in currently available ONT, iNID, or CNT devices, for instance. Such devices may also include physical connectors to operatively couple the device 30 to the connection(s) 44, 46.

The video signal processor 36 receives communication signals from the access termination 32. A video signal, illustratively a video stream for a currently selected television channel, is extracted from the received communication signals by the video signal processor 36 and output to the display device interface 40 for transfer to a display system over the connection 44. The video signal processor 36 may include or implement the functionality of a video decoder, for example. To some extent, the specific structure and operation of video signal processor 36 will be dependent upon the particular type(s) of video stream(s) that are to be processed. Those skilled in the art will be familiar with many types of video streams and how these streams are encoded and thus decoded.

It should be appreciated that video decoding represents an example of one function that could be performed by the video signal processor 36. The video signal processor 36 might also or instead perform other processing functions.

Video recording, such as Personal Video Recording (PVR) functionality, is also supported by the video signal processor 36 in some embodiments. A video signal that is extracted from communication signals by the video signal processor 36 might be stored to the video signal memory 34, and subsequently retrieved for transfer to the display system. The video signal processor 36 may concurrently process the same video signal or different video signals for storage in the video signal memory 34 and transfer to a display system. For example, a customer might wish to record a program from one television channel while recording a program from a different television channel.

The video signal translator 38 may provide a transcoding or other format conversion function. A video signal that is output from the video signal processor 36 in a first format is translated by the video signal translator 38 into a second different format for transfer to the display system. Although the display device interface 40 in the device 30 is operatively coupled to both the video signal processor 36 and to the video signal translator 38, the display device interface may be operatively coupled to only one of a processor and a translator in some implementations. A video signal translator might not be provided in all embodiments, for example. Another option may be a configurable translator that could be enabled or not enabled, depending on customer requirements.

Video signal translation illustrates the possibility of multiple modes of operation of the device 30. For customers that only require a basic, standard definition video service for instance, the access termination and video processing apparatus would be very low cost, and could include the device 30 as a single embedded SoC to decode video signals and output the decoded signals on an RF cable as an analog TV channel. This would allow a service provider to deploy an IPTV service without the cost of a set top box or network cabling, with greatly reduced complexity.

While this sort of basic implementation is low cost, simple, and would work with any TV, an analog solution would support standard definition television and may be carried over a relatively poor quality interconnect in the case of RF video. Many TVs however, now have integrated digital decoders, and it is therefore possible to have a second model of delivery.

As with the analog solution noted above, a digital version includes a video signal processor 36, but additionally includes a video signal translator 38. In North America, many TVs include an ATSC receiver that is capable of decoding digital terrestrial broadcasts in both standard and high definition, and there is even a growing consumer base of TVs that can decode clear-QAM (Quadrature Amplitude Modulation) digital cable, and decrypt scrambled QAM digital cable with the assistance of a “cablecard”. Typically, these are referred to as Digital Cable Ready (DCR) TVs. In the majority of the rest of the world, digital television is provided via DVB-T broadcast. In either case, both standard definition and high definition digital signals are supported.

The video signal translator 38 in a digital implementation might receive raw video signals in MPEG-2 or some other supported video format from the video signal processor 36, re-encapsulate or otherwise translate the raw video signals, and transmit them on the display device interface 40 and the customer site connection 44, illustratively an RF cable, as though they were part of a DVB-T or ATSC terrestrially broadcast channel. If an unsupported video codec is being used in the video signal processor 36, raw video signals may be transcoded “on-the-fly” by the video signal translator 38.

It should be appreciated that the analog and digital implementations, and similarly other implementations in which a video signal translator 38 is or is not used, need not necessarily be mutually exclusive. For example, there may be an option to mix a number of digital and analog channels.

As will be apparent to those skilled in the art, a set top box normally decodes only one television channel at a time. The video signal processor 36 may also have this restriction in some embodiments. In order to support multiple different video signals such as different television channels for multiple display devices, multiple video signal processors 36 may be provided in a single apparatus.

Through the remote control interface 42, the video signal processor 36 can receive remote control signals from the display system, and adjust its operation accordingly. Channel selection and PVR are examples of video remote control functions that might be supported by the video signal processor 36. Where multiple simultaneous video signals for multiple display devices are supported, a separate video remote control device might be provided for each display device. A mapping between a remote control signal and a video stream or a video signal processor 36 might be determined, for example, on the basis of information such as a remote control device identifier in a received control signal and a mapping table stored in a memory. Video functions are thereby independently controllable for different display devices.

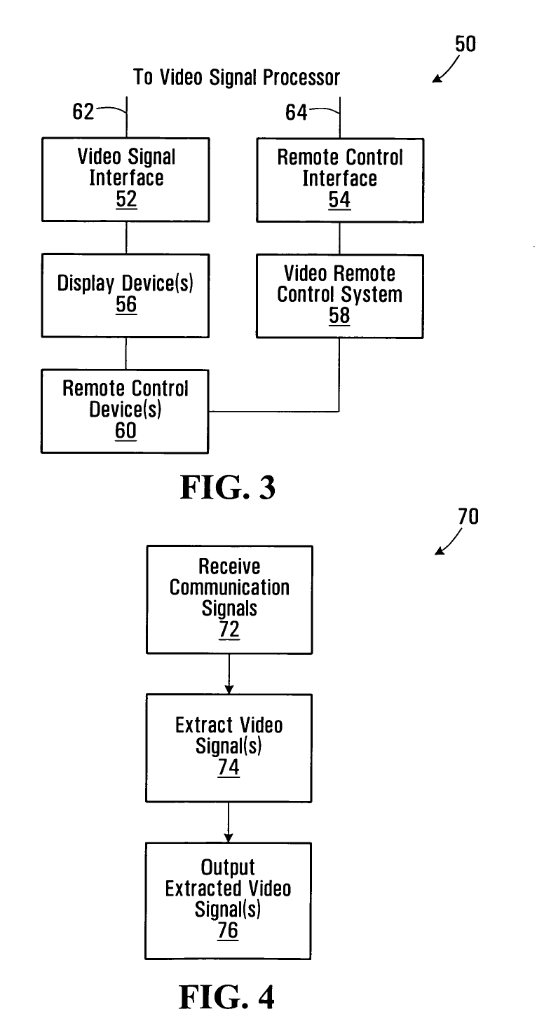

As noted above, the structure and operation of the interfaces 40, 42 will be at least to some extent implementation-dependent. An RF connection at 44 would use one type of connector as the display device interface 40, whereas a coaxial cable at 44 would use a different connector, for example. The remote control interface 42 may be the same or a different type of interface. In some embodiments, the same physical medium is used to transfer both video signals and remote control signals. Remote control functions are described in further detail below with reference to FIG. 3.

In terms of actual implementation of the device 30, there are a number of possible options, including fully integrating video processing functionality into an access termination device and/or providing plug-in functional modules. Multiple connectors might be provided, for example, to respectively connect multiple video signal processors to the access termination 32. Video signal processors may then be added to a device to allow the simultaneous use of additional channels. Electronic card connectors represent one type of connector that may be useful for this purpose.

The video signal processor 36 could also or instead include connectors for respectively connecting to other modular components, such as the video signal memory 34 and the video signal translator 38.

Modular components provide enhanced flexibility for customizing the same basic termination/processing device to meet different requirements for different customers.

FIG. 3 is a block diagram of a display system. The display system 50 includes a video signal interface 52, one or more display devices 56 operatively coupled to the video signal interface, a remote control interface 54, a video remote control system 58 operatively coupled to the remote control interface 54, and one or more remote control devices 60 that may be operatively coupled to the display device(s), the video remote control system, or both.

The components of the display system 50, like those of the device 30 (FIG. 2), may be implemented in hardware, software, firmware, or combinations thereof, and accordingly are described herein primarily in terms of their functions.

The video signal interface 52 enables the display device(s) to receive video signals through a customer site connection 62. The interface and connection 52, 54 are compatible with the corresponding display device interface 40 and the connection 44 of the device 30.

Received video signals are displayed on a display device 56. Multiple display devices 56 may display the same video signals or, in some embodiments, different video signals. Another embodiment supports a separate means of carrying an existing standard signal such as a High Definition Multimedia Interface (HDMI) signal, for example, over the connection 62 and provides a dongle or other device at the display system 50 to extract that signal from the connection 62.

Channel selection, recording, and other video functions are controllable using a remote control device 60. In the case of a multi-function or universal remote control device, the same control device may be used to control both video functions and display device functions. For the purposes of video function control, the video remote control system 58 receives control signals from the remote control device(s) 60 and transfers those control signals to an access termination and video signal processing system through the remote control interface 54 and the connection 64.

The remote control device(s) 60 may be operatively coupled to the video remote control system 58 in any of various ways. For example, the video remote control system 58 may include an infrared (IR) receiver that is co-located with a display device 56. Received IR control signals may be converted into a suitable form for transfer over the connection 64 by the video remote control system 58 and/or the remote control interface 54. The video remote control system 58 might convert IR signals to electrical signals, while the remote control interface 54 may, for example, convert the electrical signals into wireless signals for transfer over a wireless connection 64. Remote control signals might instead be sent to a video signal processor on the same physical connection that is used to transfer video signals to the display device(s) 56.

In another embodiment, wireless remote control device(s) 60 interface directly to a wireless remote interface in the access termination/video processing device.

More generally, the video remote control system 58 and the remote control interface 54 represent an example of a control interface for receiving video control signals from a user.

A combination of technologies might also be used. In one embodiment, a wireless receiver is placed in a logical position, such as at the centre of a customer's house, and receives remote control signals from the remote control device(s) 60 and sends them back to an access termination/processing device via a coaxial cable. Multiple wireless transceivers, one per remote control device 60, could also be deployed in this manner. Any of these solutions would allow a remote control device to be carried from room to room and still be operational.

The capability to display multiple video signals simultaneously on different display devices 56 at the same customer site might also involve some sort of differentiation of remote control signals. Each remote control device 60 could be configured to include a unique identifier in any remote control signals it generates. This may allow a central component of a remote control system to handle remote control signals from all remote control devices at a customer site. A video stream or video signal processor at an access termination/processing device that is to be controlled by a received remote control signal can then be identified on the basis of the unique identifier. Another option would be to provide separate remote control device-specific components in the video remote control system 58, and to configure those components to include respective unique identifiers in control signals to be transmitted back to an access termination/processing device.

It should be appreciated that even with one video signal processor, video signals on the connection 62 may be received by multiple display devices 56. The same channel may be displayed at the same time on multiple TVs, for instance. When the user changes the channel, the channel is changed for all TVs at once.

Further mechanisms to match remote control signals to video streams are also possible.

FIG. 4 is a flow diagram illustrating a method according to another embodiment of the invention. The method 70 may be implemented, for example, in a system for terminating an access communication link that operatively couples a video service customer site to a communication network. Communication signals that include video signals are distributed to video service customer sites in the communication network, and are received at 72.

At 74, one or more video signals are extracted from the received communication signals. The method proceeds at 76 with outputting the extracted video signal(s) for transfer to one or more display systems at the video service customer site.

It should be appreciated that the method 70 is illustrative of one embodiment of the invention. Other embodiments may include further, fewer, or different operations performed in a similar or different order than shown.

For example, the operations shown in FIG. 4 may be performed in any of various ways, some of which have been explicitly described above. The operation of extracting a video signal at 74, for instance, may involve decoding the video signal.

Video signal recording, translation, and remote control operations have also been described above, and could be performed in some embodiments.

Further variations may be or become apparent to those skilled in the art.

According to embodiments of the invention as disclosed herein, IPTV deployment is drastically simplified. In many cases, no additional wiring is required, making mass delivery of a basic IP video product very simple in comparison with currently available techniques. A high value video service can be deployed independently of other IP-based services.

What has been described is merely illustrative of the application of principles of embodiments of the invention. Other arrangements and methods can be implemented by those skilled in the art without departing from the scope of the present invention.

For example, the divisions of functions shown in FIGS. 2 and 3 are illustrative of embodiments of the invention. Further, fewer, or different elements may be used to implement the techniques disclosed herein.

In addition, although described primarily in the context of apparatus and methods, other implementations of the invention are also contemplated, as instructions stored on a machine-readable medium, for example.

Another possible variation relates to the delivery of video signals over customer site connections. In one embodiment, multiple television channels are delivered over different RF channels on a customer site connection.

Some embodiments also maintain support for typical functions of a set top box, such as interactive channel guide, etc., since full set top box functionality may be provided by a video signal processor and other components at an access termination/processing device.

We claim:

1. A device comprising:
an access termination for terminating and connection to an access communication link that operatively couples a video service customer site to a communication network, the communication network distributing communication signals comprising video signals to a plurality of video service customer sites; and
a video signal processor operatively coupled to the access termination and operable to receive communication signals from the access termination, to extract a video signal from the received communication signals, and to output the extracted video signal for transfer to a display system at the video service customer site.

2. The device of claim 1, wherein the communication network is an Internet Protocol (IP) network, and wherein the video signals comprise television signals.

3. The device of claim 1, wherein the video signal processor comprises a video decoder that is operable to extract a video signal from the received communication signals by decoding the video signal.

4. The device of claim 1, further comprising:
a video signal memory operatively coupled to the video signal processor,
wherein the video signal processor is further operable to store the extracted video signal to the video signal memory, and to subsequently retrieve the stored video signal from the video signal memory for transfer to the display system.

5. The device of claim 1, further comprising:
a video signal memory operatively coupled to the video signal processor,
wherein the video signal processor is further operable to extract a further video signal from the received communication signals, to store the extracted further video signal to the video signal memory, and to subsequently retrieve the stored further video signal from the video signal memory for transfer to the display system.

6. The device of claim 1, further comprising:
a remote control interface operatively coupled to the video signal processor and operable to receive a remote control signal from the display system,
wherein the video signal processor is further operable to receive the remote control signal from the remote control interface and to adjust its operation in accordance with the received remote control signal.

7. The device of claim 6, wherein the remote control signal comprises a video signal selection, and wherein the video signal processor adjusts its operation to extract the selected video signal from the received communication signals responsive to the remote control signal.

8. The device of claim 6, further comprising:
a display system interface operatively coupled to the video signal processor and operable to receive the extracted video signal from the video signal processor and to transfer the extracted video signal to the display system over a customer site connection,
wherein the remote control interface is operable to receive the remote control signal from the display system over the customer site connection.

9. The device of claim 1, further comprising:
a video signal translator operatively coupled to the video signal processor and operable to receive the extracted video signal from the video signal processor in a first format, and to translate the extracted video signal into a second different format for transfer to the display system.

10. The device of claim 1, wherein the video signal processor comprises a modular video signal processing component, the device further comprising:
a plurality of connectors for respectively operatively coupling a plurality of video signal processors including the video signal processor to the access termination.

11. The device of claim 1, wherein the video signal processor comprises a plurality of video signal processor connectors for respectively operatively coupling a plurality of modular components to the video signal processors, the plurality of modular components comprising a video signal memory and a video signal translator.

12. In a device for terminating an access communication link that operatively couples a video service customer site to a communication network in which communication signals comprising video signals are distributed to a plurality of video service customer sites, a method comprising:
extracting a video signal from the received communication signals; and
outputting the extracted video signal for transfer to a display system at the video service customer site.

13. The method of claim 12, wherein the communication network is an Internet Protocol (IP) network, and wherein the video signals comprise television signals.

14. The method of claim 12, wherein extracting comprises decoding the video signal.

15. The method of claim 12, further comprising:
storing the extracted video signal to a video signal memory,
wherein outputting comprises subsequently retrieving the stored video signal from the video signal memory for transfer to the display system.

16. The method of claim 12, further comprising:
receiving a remote control signal from the display system; and
adjusting the extracting in accordance with the received remote control signal.

17. The method of claim 16, further comprising:
transferring the extracted video signal to the display system over a customer site connection,
wherein receiving a remote control signal comprises receiving the remote control signal from the display system over the customer site connection.

18. The method of claim 12, wherein the extracted video signal comprises a video signal format, the method further comprising:
translating the extracted video signal into a different video signal format for transfer to the display system.

19. A machine-readable medium storing instructions which when executed perform the method of claim 12.

20. A video display control system comprising:
a video signal interface for receiving, on a connection to a video signal processor, video signals extracted by the video signal processor from communication signals distributed in a communication network; and
a video control interface operatively coupled to the connection and operable to receive a video control signal from a user and to transfer the received video control signal to the video signal processor over the connection.
